(19) United States
(12) Patent Application Publication
(10) Pub. No.: US 2024/0256963 A1
(43) Pub. Date: Aug. 1, 2024

(54) SYSTEM AND METHOD FOR FAST SPARSE DIFFERENTIALLY PRIVATE REGRESSION

(71) Applicant: Booz Allen Hamilton Inc., McLean, VA (US)

(72) Inventors: Edward Simon Paster Raff, Jamesville, NY (US); Amol Ashish Khanna, Nashua, NH (US); Fred Sun Lu, Glendale, CA (US)

(73) Assignee: Booz Allen Hamilton Inc., McLean, VA (US)

(21) Appl. No.: 18/423,774

(22) Filed: Jan. 26, 2024

Related U.S. Application Data
(60) Provisional application No. 63/481,657, filed on Jan. 26, 2023.

(51) Int. Cl. G06N 20/00

(52) U.S. Cl. CPC G06N 20/00

(57) ABSTRACT

Exemplary systems and methods are directed to training a machine learning model and for preventing leakage of training data by the machine learning model subsequent to training. A processor is configured to convert a sparse dataset into a matrix of plural data coordinates, generate a priority queue populated with the plural data coordinates, and iteratively select a data coordinate from the priority queue. Plural model values are calculated such that any zero value in the sparse dataset is avoided while maintaining a same result. A next feature is selected, and its weight is altered. Plural variables of the matrix are updated based on the altered weight value, and the priority queue is updated to adjust a priority of the data coordinates based on the update to the plural variables. The process is repeated for each next data coordinate until the model converges to a solution based on the model weights.

### RELATED APPLICATIONS

This application claims priority under 35 U.S.C. 119 to provisional U.S. application No. 63/481,657 filed on Jan. 26, 2023, the entire content of which is hereby incorporated by reference.

### FIELD

The present disclosure relates to a system and method for training a model and preventing leakage of training data subsequent to the model being trained.

### BACKGROUND

Differential Privacy (DP) is an effective tool for machine learning practitioners and researchers to ensure the privacy of the individual data used in model construction. DP is a process that adds noise to data to protect the privacy of the individual data. As described in Dwork et al., “Calibrating Noise to Sensitivity in Private Data Analysis” (2006), given parameters ϵ and δ, where ϵ is leakage and δ is probability tolerance of information being leaked, on any two datasets D and D′ differing on one example, an (approximately) differentially private randomized algorithm A satisfies Pr[A(D)∈O]≤exp{ϵ}Pr[A(D′)∈O]+δ for any O⊆image(A). Note that lower values of ϵ and δ correspond to stronger privacy.

While DP has had many successes in industry and government, DP-based machine learning methods have made little progress for sparse high-dimensional problems. Known uses of DP-based learning methods are discussed in Machanavajjhala et al., “Privacy: Theory meets Practice on the Map” (2008); Rogers et al., “LinkedIn's Audience Engagements API: A Privacy Preserving Data Analytics System at Scale” (2020); and Erlingsson et al., “RAPPOR: Randomized Aggregatable Privacy-Preserving Ordinal Response” (2014). Issues with sparse high-dimensional problems arise because, given a dataset with D features and a training algorithm with T iterations, all DP regression algorithms require at least O(TD) training complexity. This makes it impractical to use these algorithms on any dataset with a large number of features.

For this reason, a differentially private (DP) machine learning algorithm which scales to sparse datasets with high values of D is needed. The solution can begin with a LASSO regularized logistic regression model as discussed in Tibshirani, “Regression Shrinkage and Selection Via the Lasso” (1994), which provides that given a dataset {x1, . . . , xN}∈RD which can be represented as a design matrix X∈RN×D, {y1, . . . , yN}∈{0, 1}, and a maximum L1 norm λ, Given these parameters the following equation can be solved:

$$\hat{w} = {arg min}_{w ∈ {R}^{D} : ‖ w ‖ 1 \leq λ} \frac{1}{N} {\sum }_{i = 1}^{N} - {y}_{i} log σ ( w \cdot {x}_{i} ) - ( 1 - {y}^{i} ) log σ ( w \cdot {x}^{i} ) )$$

where

$$σ ( u ) = \frac{1}{1 + exp \{ - u \}}$$

is the sigmoid function. When considering DP, the Frank-Wolfe algorithm is known for L1 constrained optimization and is regularly used in DP applications. Examples of use of the Frank-Wolfe algorithm are discussed in Bomze et al., “Frank-Wolfe and friends: a journey into projection-free first order optimization methods” (2021); and Iyengar et al., “Towards Practical Differentially Private Convex Optimization” (2019). The Frank-Wolfe algorithm is also desirable because when properly initialized, its solutions can have at most T nonzero coefficients for T training iterations.

For DP regression, the addition of noise to each variable has limited exploration of sparse datasets. Most prior work has addressed one regression problem with less than 100 dense variables or are entirely theoretical with no empirical results. Examples of some prior work is discussed in Wang & Gu, “Differentially Private Iterative Gradient Hard Thresholding for Sparse Learning” (2019); Wang & Zhang, “Differential privacy for sparse classification learning” (2020); Talwar et al., “Nearly optimal private lasso” (2015a); Kumar & Deisenroth, “Differentially Private Empirical Risk Minimization with Sparsity-Inducing Norms” (2019); Kifer et al., “Private Convex Empirical Risk Minimization and High-dimensional Regression” (2012). Currently, the largest scale attempt for high-dimensional logistic regression with DP is described by Iyengar et al., “Towards Practical Differentially Private Convex Optimization” (2019), which introduces an improved objective perturbation method for maintaining DP with convex optimization. This technique required using L-BFGS, which is O(D) complexity for sparse data and produces completely dense solution vectors w, as described in Liu & Nocedal, “On the limited memory BFGS method for large scale optimization” (1989). In addition, Wang & Gu discuss in “Differentially Private Iterative Gradient Hard Thresholding for Sparse Learning” (2019) attempts to train an algorithm on the RCV1 dataset but with worse results and similar big-O complexity as described in Iyengar et al. “Towards Practical Differentially Private Convex Optimization” (2019). Jain & Thakurta in “(Near) Dimension Independent Risk Bounds for Differentially Private Learning” (2014) claim to tackle the URL dataset with 20M variables, their solution does so by sub-sampling just 0.29% of the data for training and 0.13% of the data for validation, making the results suspect and non-scalable. Lastly, a larger survey by Jayaraman & Evans “Evaluating Differentially Private Machine Learning in Practice” (2019) shows no prior work considering the sparsity of DP solutions and all other works tackling datasets with less than 5000 features.

In addition to no DP regression algorithm handling sparse datasets, no known techniques improve upon the O(D) dependency of Frank-Wolfe on sparse data. Prior works have noted this dependence as a limit to its scalability, and column sub-sampling approaches are one method which have been used to mitigate that cost. For example, the dependency of Frank-Wolfe on sparse data is discussed by Lacoste-Julien et al., “Block-Coordinate Frank-Wolfe Optimization for Structural SVMs” (2013); Bomze et al., “Frank-Wolfe and friends: a journey into projection-free first order optimization methods” (2021); Kerdreux et al., “Frank-Wolfe with Subsampling Oracle” (2018). Others, such as Moharrer & Ioannidis, “Distributing Frank-Wolfe via Map-Reduce” (2018) have looked at distributed Map-Reduce implementations as a means of scaling the Frank-Wolfe algorithm.

The known COPT library is a Frank-Wolfe implementation that attempts to support sparse datasets. The COPT library is discussed in Pedregosa & Seong, “Openopt/Copt: VO.4” (2018). However, there are currently no DP regression libraries that support sparse datasets (Holohan et al., “Diffprivlib: The IBM Differential Privacy Library” (2019)).

### SUMMARY

An exemplary method for training a model is disclosed, the method comprising: storing, in memory, program code for training a machine learning model and for preventing leakage of training data by the machine learning model subsequent to training; and executing, in a processor, the program code stored in memory, the program code causing the processor to be configured to execute operations including: a. receiving a dataset populated predominately with zero data values as a sparse dataset; b. converting the sparse dataset into a matrix of plural data coordinates defined by a feature value and a column gradient; c. generating a priority queue populated with the plural data coordinates; d. iteratively selecting a data coordinate from the priority queue, each coordinate indicating a next covariate to update in the machine learning model; e. calculating based on the selected data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model, in such a manner that any zero value in the sparse dataset is avoided in use while maintaining a same result; f. selecting a next data coordinate from the plural data coordinates in the priority queue, the next data coordinate corresponding to a next feature for training the model; g. altering a weight value of the next feature to produce an altered weight value; h. updating plural variables of the matrix based on the altered weight value, the plural variables being located in rows of the matrix that include the next feature, the plural variables including at least the column gradient, the dot product of each row of the matrix that includes the next feature in the matrix with the altered weight value, and the base convergence gap value associated with training of the machine learning model; i. updating the priority queue to adjust a priority of the data coordinates based on the update to the plural variables; j. repeating steps f to i until the model has converged to a solution; and k. storing weights of the model associated with the solution.

An exemplary system for training a model is disclosed, the system comprising: memory configured to store program code for training a machine learning model and for preventing leakage of training data by the machine learning model subsequent to training; and a processor configured to execute the program code stored in memory, the program code causing the processor to be configured to: a. receive a dataset populated predominately with zero data values as a sparse dataset; b. convert the sparse dataset into a matrix of plural data coordinates defined by a feature value and a column gradient; c. generate a priority queue populated with the plural data coordinates; d. iteratively select a data coordinate from the priority queue, each data a next covariate to update in the machine learning model; e. calculate, based on the first data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model in such a manner that any zero value in the sparse dataset is avoided in use while maintaining a same result; f. select a next data coordinate from the plural data coordinates in the priority queue, the next data coordinate corresponding to a next feature for training the model; g. alter a weight value of the next feature to produce an altered weight value; h. update plural variables of the matrix based on the altered weight value, the plural variables being located in rows of the matrix that include the next feature, the plural variables including at least the column gradient, the dot product of each row of the matrix that includes the next feature in the matrix with the altered weight value, and the base convergence gap value associated with training of the machine learning model; i. update the priority queue to adjust a priority of the data coordinates based on the update to the plural variables; j. repeat steps f to i until the model has converged to a solution; and k. store weights of the model associated with the solution.

An exemplary computer program product is disclosed, the computer program product being encoded with program code for training a machine learning model and for preventing leakage of training data by the machine learning model subsequent to training such that when placed in communicable contact with a processor, the computer program product causes the processor to be configured to execute operations including: a. receiving a dataset populated predominately with zero data values as a sparse dataset; b. converting the sparse dataset into a matrix of plural data coordinates defined by a feature value and a column gradient; c. generating a priority queue populated with the plural data coordinates; d. iteratively selecting a data coordinate from the priority queue, each coordinate indicating a next covariate to update in the machine learning model; e. calculating based on the selected data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model, in such a manner that any zero value in the sparse dataset is avoided in use while maintaining a same result; f. selecting a next data coordinate from the plural data coordinates in the priority queue, the next data coordinate corresponding to a next feature for training the model; g. altering a weight value of the next feature to produce an altered weight value; h. updating plural variables of the matrix based on the altered weight value, the plural variables being located in rows of the matrix that include the next feature, the plural variables including at least the column gradient, the dot product of each row of the matrix that includes the next feature in the matrix with the altered weight value, and the base convergence gap value associated with training of the machine learning model; i. updating the priority queue to adjust a priority of the data coordinates based on the update to the plural variables; and j. repeating steps f to i until the model has converged to a solution.

### BRIEF DESCRIPTION OF THE DRAWINGS

Exemplary embodiments are best understood from the following detailed description when read in conjunction with the accompanying drawings. Included in the drawings are the following figures:

FIG. 1 illustrates a first system for differentially private training on a sparse dataset in accordance with an exemplary embodiment of the present disclosure.

FIG. 2 illustrates a second system for differentially private training on a sparse dataset in accordance with an exemplary embodiment.

FIG. 3 illustrates a method for differentially private training on a sparse dataset in accordance with an exemplary embodiment.

FIG. 4 illustrates a process for selecting a next data coordinate for analysis in accordance with an exemplary embodiment of the present disclosure.

FIG. 5 illustrates a plot of convergence gap to number of iterations for Algorithm A in accordance with an exemplary embodiment of the present disclosure.

FIG. 6 illustrates a plot of items popped from a Figonacci Heap over the non-zeroes in the final solution to the number of iterations in accordance with an exemplary embodiment of the present disclosure.

FIG. 7 illustrates a plot of convergence rate as a function of the number of FLOPs to obtain it in accordance with an exemplary embodiment of the present disclosure.

FIG. 8 illustrates a plot of total cumulative reduction in runtime (y-axis) against the number of completed iterations (x-axis) of Algorithm C in accordance with an exemplary embodiment of the present disclosure.

FIG. 9 illustrates the structure of a computing system in accordance with an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

In contrast, our work does no sub-sampling and directly takes advantage of dataset sparsity in training high-dimensional problems. Our use of the Frank-Wolfe algorithm also means our solution is sparse, with no more than T non-zero coefficients for T iterations. However, our method is the first to address dataset sparsity directly within the Frank-Wolfe algorithm.

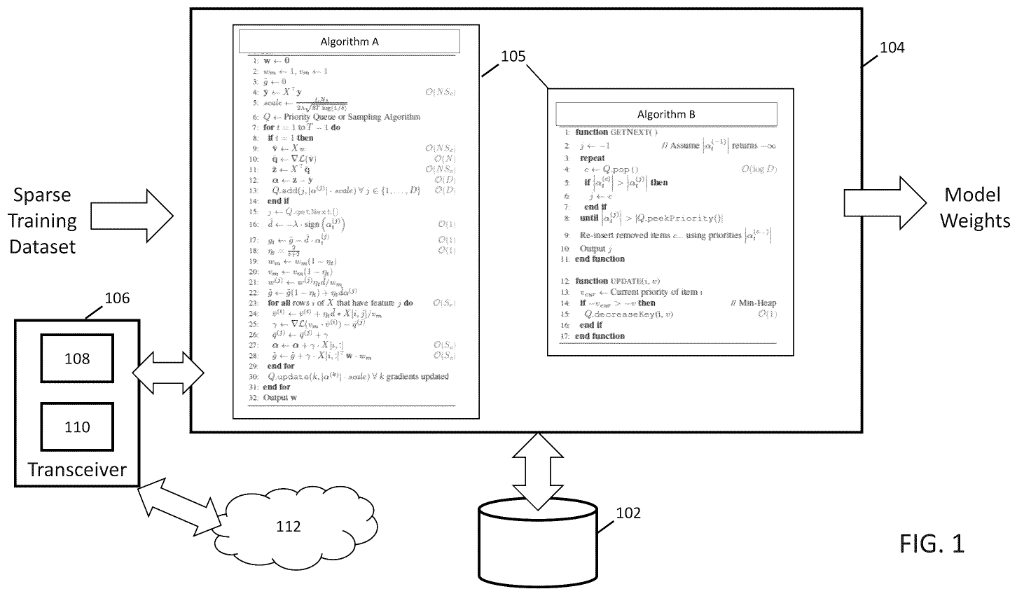

FIG. 1 illustrates a system for differentially private training on a sparse dataset in accordance with an exemplary embodiment of the present disclosure.

As shown in FIG. 1, the system 100 can include a computing system or device having a memory device 102 and a processor 104. The memory device 102 can include one or more devices configured to store data such as program code 105 (e.g., Algorithms A and B) for performing an algorithm that trains a machine learning model and for preventing leakage of training data by the machine learning model subsequent to training. The processor 104 can be configured to access the program code 105 stored in the memory device 102 and execute the program code 105 to perform the operations associated with the algorithm. The computing system can be arranged such that the memory device 102 and the processor 104 are integrated or disposed in a common housing. According to another exemplary embodiment, the computing device can be arranged such the memory device 102 is external to the housing.

The computing device can also include a network or communication interface 106 configured to establish a wired or wireless connection with one or more remote devices for communicating data or data signals. The communication interface 106 can be configured to operate as a receiving device or a receiver 108, for receiving data or data signals from a remote or external device. The communication interface 106 can also be configured operate as a transmitting device or a transmitter 110 for sending data or data signals to one or more remote devices over the wired or wireless connection.

According to exemplary embodiments of the present disclosure, the processor 104 can execute the program code 105 stored in the memory device 102 to cause the computing device to perform operations associated with training a machine learning model and for preventing leakage of training data by the machine learning model subsequent to training. In performing the algorithms A and C, the receiver 108 can receive a dataset populated predominately with zero data values as a sparse dataset. For example, the communication interface 106 can establish a connection with a remote device, such that the receiver 108 can receive the sparse data set. According to an exemplary embodiment, the sparse dataset can be stored in the memory device 102. As shown in lines 1-5 of program code 105, the processor 104 converts the sparse dataset into a matrix of plural data coordinates defined by a feature value and a column gradient, and in line 6 generates a priority queue Q populated with the plural data coordinates. In lines 8-15 of program code 105, the processor 104 iteratively selects a data coordinate from the priority queue Q each coordinate indicating a next covariate to update in the machine learning model. Based on lines 23-29, the processor 105 calculates based on the selected data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model, in such a manner that any zero value in the sparse dataset is avoided in use while maintaining a same result. The processor 105 reverts back to line 15 of the program code 105 and selects a next data coordinate from the plural data coordinates in the priority queue Q, the next data coordinate corresponding to a next feature for training the model. At lines 16-22 of the program code 105, the processor 104 alters a weight value of the next feature to produce an altered weight. The processor 104 then updates plural variables of the matrix based on the altered weight value (lines 24-28), the plural variables being located in rows of the matrix that include the next feature, the plural variables including at least the column gradient, the dot product of each row of the matrix that includes the next feature j in the matrix with the altered weight value, and the base convergence gap value g associated with training of the machine learning model value. In executing line 30 of the program code 105, the processor 104 updates the priority queue Q to adjust a priority of the data coordinates based on the update to the plural variables. The processor 104 is configured to select the next data coordinate from the priority queue Q and alter the weight value, update plural variables of the matrix based on the altered weight value, and update the priority queue based on the updated variables until the model has converged to a solution w. Once a solution is determined the processor 104 stores the model weights associated with the solution w in the memory device 102.

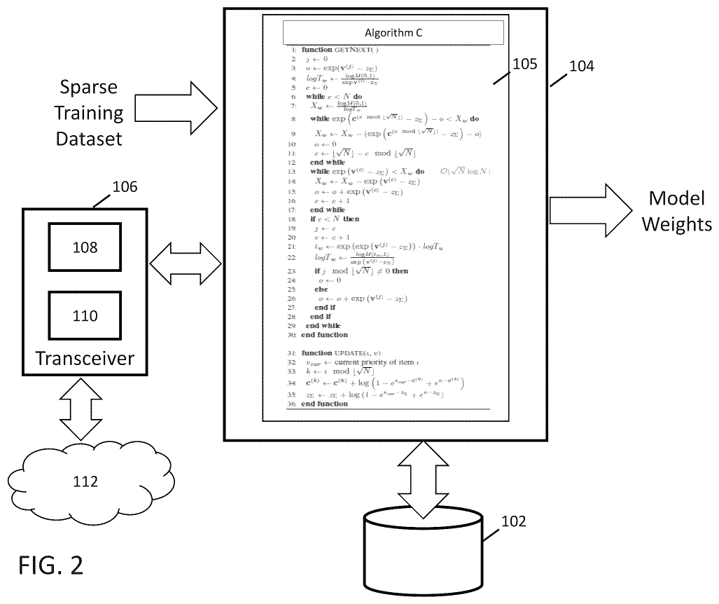

FIG. 2 illustrates a second system for differentially private training on a sparse dataset in accordance with an exemplary embodiment.

As shown in FIG. 2, lines 1-7 of the program code 107 the processor 104 multiplies the data coordinates in the priority queue by a scaling variable having a noise parameter. The processor 104 computes a threshold weight value for each feature to be used in training the machine learning model (line 6). For example, the processor 104 operates on a on a stream of items with weights wᵢ, and in O(1) space produces a valid weighted sample from the stream. The processor 104 generates plural groups of data coordinates of the matrix by populating each group with data coordinates that are randomly selected based on a proportionality of a corresponding weight value to the threshold weight value. The data coordinates of each group are compiled by identifying data coordinates in the current group that were included in a previous comparison, and subtracting a weight value of the identified data coordinates in the previous comparison from the threshold weight value. As shown in lines 8-11, the processor 104 computes a cumulative weight Σᵢwᵢ value for each group of data coordinates and compares the cumulative weight value of a current group of the plural groups to the threshold weight value T_{w}. The processor 104 selects a new group of compiled data coordinates from the plural groups when the cumulative weight value Σᵢwᵢ of the current group is smaller than the threshold weight value T_{w}. When the cumulative weight value Σᵢwᵢ of the current group is larger than the threshold weight value T_{w}, the processor 104 inspects each data coordinate in the current group. Based on the inspection, the processor 104 identifies the next data coordinate that is to be processed in the current group. For each group, the processor 104 repeats computing a cumulative weight value, comparing the cumulative weight value to a threshold weight value, and based on the comparison selecting a new group of compiled data coordinates or inspecting each data coordinate in the current group to maintain privacy of the data according to a predetermined sensitivity.

The algorithm shown in FIG. 2 uses a known exponential mechanism in which each coordinate is given a weight

$$∝ exp ( \frac{∈ u ( j )}{2 Δ u} )$$

where u(j) is the score of the j^{th} item and Δu is the sensitivity. The exponential mechanism, however, presents challenges for efficient execution by the processor 104 in that values must be selected from a weighted dataset in sub-linear time over multiple iterations, and at the same time an overflow for relatively small gradient magnitudes avoiding caused by raising a gradient to an exponential must be avoided to prevent processing overflow. According to exemplary embodiments of the present disclosure, the algorithm of FIG. 2 improves upon the known exponential mechanism by performing operations on a stream of items with weights wᵢ a valid weighted sample c(k) and z_{Σ} can be generated from the stream at a constant time complexity O(1). The constant time complexity is achieved by the processor 104 being configured to compute a randomized threshold Tw and processing the samples until the value of the cumulative weights is greater than the threshold Tw, such that Σᵢwᵢ>Tw. When this occurs the final item in the sum becomes the new sample. The processor 104 computes a new random threshold Tw, and the process continues on the samples until the stream is empty. The random thresholds Tw are computed at a time complexity of O(log D) for a stream of D items. The processor 104 compiles large groups of the weights from the fixed set of D items in the stream and keeps track of their collective weight. As a result, the DP computation is numerically stable for a wide range of weights and can draw in a new sample in an efficient time complexity of O(√D log D). If the cumulative weight of the group is smaller than the threshold Tw, then the processor 104 can skip any further processing on the group. On the other hand, if the cumulative weight of the group is smaller than the threshold Tw, then the processor 104 inspects each item in the group.

According to an exemplary embodiment, the scale of gradients can change by four or more orders of magnitude due to the evolution of the gradient during training and the exponentiation of the Exponential sampler. As a result, the processor can execute the logic at a loc scale time complexity such that a total log-sum weight z_{Σ} of the items in a group is tracked. The processor performs and exponentiation of a log-weight then subtracts the resulting value by performing a log-sum-exp operation so that the sample weights are maintained in a numerically stable range. According to an exemplary embodiment, DP can be maintained by adding an offset of 10⁻¹⁵ noise value to the dataset.

According to an exemplary embodiment, the processor 104 can be configured to compile up to √D groups where each group has √D members. The processor 104 can compute a vector c that corresponds to the log-sum-weight value computed for each group. As shown at lines 34 and 35 of Algorithm C, the processor 104 can update the log-sum-exp value so that the group sum c(k) and total sum z_{Σ} are updated, where the updated values are in a log-scale format. The group sum c(k) is larger than the total sum z_{Σ}. For this reason, the processor 104 is configured to use c(k) and z_{Σ} as maximal values to normalize the log-sum-exp value in the update operation. Based on the instruction, at lines 31 and 32 of Algorithm C, the processor 104 can select the representative value (i.e., the coordinate selected to be updated) to update for the change in weight of the i^{th} item in the group.

As shown in lines 8-12 of the algorithm C, the processor 104 is configured to execute a loop which skips over one or more groups of weights and can operate on a partial groups of weights based on the last value operated on during a previous iteration, such as a value located in the middle of a group. As a result, the processor 104 can use a group offset o that subtracts the weight of items already visited or skipped in the group. To address a situation where the starting location from a previous iteration is in the middle of a group, at line 11, of Algorithm C the starting location within the current group is incremented by the group size modulo the current position, so that each step starts at the beginning of the next group regardless of starting position. From lines 13-17 of Algorithm C, the processor 104 is configured to operate on each item within a compiled group, when the collective weights of a group are larger than the threshold T_{w}.

Algorithm C is cache friendly as it configures the processor 104 to perform linear scans over √D items at a time which allows more items to be available in local memory making pre-fetching very easy. Based on the pre-fetching operation, the processor 104 only has O(log D) cache-misses, or instances when the items are not available in local memory when lies 13-19 of Algorithm C are being performed.

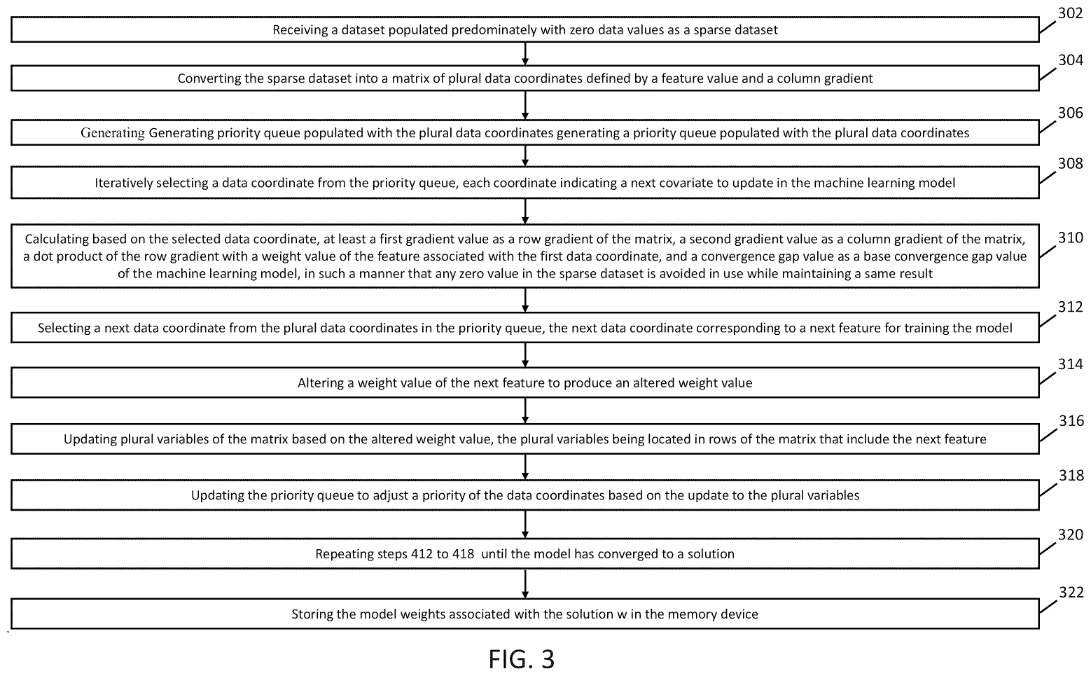

FIG. 3 illustrates a method for differentially private training on a sparse dataset in accordance with an exemplary embodiment. The method is executed by the system 100, which includes memory device 102 and the processor 104. The memory device 102 stores program code for training a machine learning model and for preventing leakage of training data by the machine learning model subsequent to training. The processor 104 executes the program code stored in memory 102, the program code causing the processor 104 to be configured to execute plural operations. As shown in FIG. 3, in Step 302, the processor 104 receives a dataset populated predominately with zero data values as a sparse dataset. The dataset can be received by accessing a local memory device or can be received from a remote device over a network. In step 304, the processor 104 converts the sparse dataset into a matrix of plural data coordinates defined by a feature value and a column gradient. The processor 104 generates a priority queue populated with the plural data coordinates (Step 306), and iteratively selects a data coordinate from the priority queue (Step 308). According to an exemplary embodiment, each coordinate indicates a next covariate to update in the machine learning model. In Step 310, the processor 104 calculates based on the selected data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model. According to an exemplary embodiment, the processor 104 performs the calculation in such a manner that any zero value in the sparse dataset is avoided in use while maintaining a same result. Algorithms A and C are designed to make iterative computations over the sparse dataset unnecessary as the priority queue keeps all the information required. For example, lines 15-30 of Algorithm A avoid performing work on zeroes by tracking only the computations that will result in a material change to the resulting calculation. In addition, Algorithm C avoids performing computations on non-zero values that will not meaningfully contribute to the final solution. The processor 104 selects a next data coordinate from the plural data coordinates in the priority queue, the next data coordinate corresponding to a next feature for training the model (Step 312).

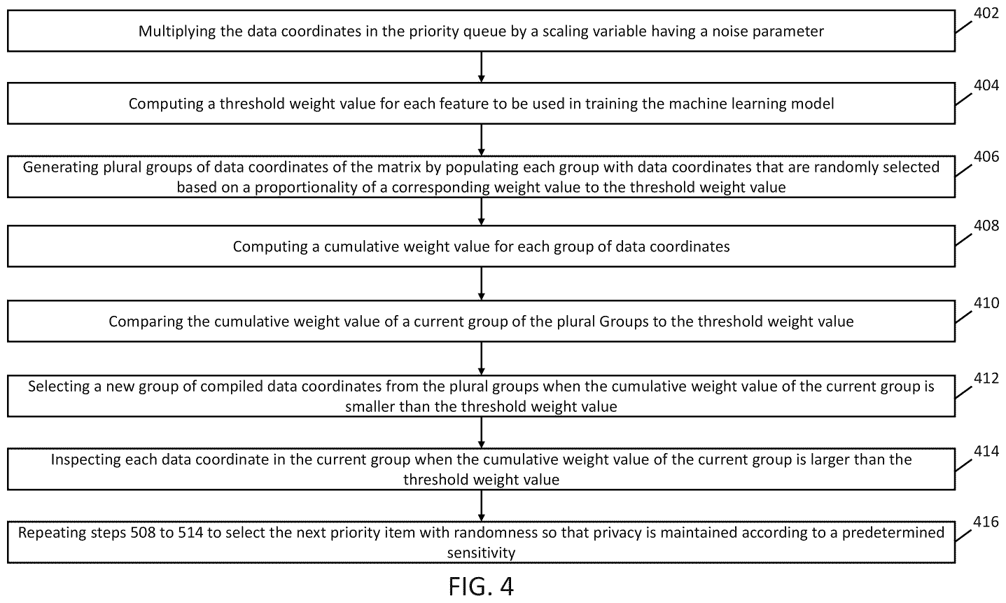

FIG. 4 illustrates a process for selecting a next data coordinate for analysis in accordance with an exemplary embodiment of the present disclosure. As shown in FIG. 4, the processor 104 multiplies the data coordinates in the priority queue by a scaling variable having a noise parameter (Step 402), computes a threshold weight value for each feature to be used in training the machine learning model (Step 404), and generates plural groups of data coordinates of the matrix by populating each group with data coordinates that are randomly selected based on a proportionality of a corresponding weight value to the threshold weight value (Step 406). The processor 104 computes a cumulative weight value Σᵢwᵢ for each group of data coordinates (Step 408) and compares the cumulative weight value Σᵢwᵢ of a current group of the plural groups to the threshold weight value T_{w} (Step 410). The processor 104 selects a new group of compiled data coordinates from the plural groups when the cumulative weight value Σᵢwᵢ of the current group is smaller than the threshold weight value T_{w} (Step 412). When the cumulative weight value Σᵢwᵢ of the current group is larger than the threshold weight value T_{w}, the processor 104 inspects each data coordinate in the current group (Step 414).

Once the next data coordinate is selected, at step 314 of FIG. 3, the processor 104 alters a weight value of the next feature to produce an altered weight value. The processor 104 updates plural variables of the matrix based on the altered weight value (Step 316). According to an exemplary embodiment, the plural variables being located in rows of the matrix that include the next feature. The plural variables including at least the column gradient, the dot product of each row of the matrix that includes the next feature in the matrix with the altered weight value, and the base convergence gap value associated with training of the machine learning model. The processor 104 updates the priority queue to adjust a priority of the data coordinates based on the update to the plural variables (Step 318). Steps 314 to 318 are repeated by the processor 104 until the model has converged to a solution (Step 320). When a solution has been determined, in Step 322 the processor 104 stores the model weights associated with the solution w in the memory device 102 (Step 322).

According to an exemplary embodiment systems and methods of the present disclosure can be implemented on sparse datasets listed in Table 1, where D≥N.

TABLE 1

| Dataset | N | D |
|---|---|---|
| RCV1 | 20,242 | 47,236 |
| 20 Newsgroups.Binary “News 20” | 19,996 | 1,355,191 |
| Malicious URLs, “URL” | 2,396,130 | 3,231,961 |
| Webb Spam Corpus, “Web” | 350,000 | 16,609,143 |
| KDD2010 (Algebra), “KDDA” | 8,407,752 | 20,126,830 |

The processor 104 can be configured such that the total number of iterations T is equal to 4000 (T=4000) and a maximum L1 norm for the Lasso constraint λ is 50 (λ) in all tests across all datasets.

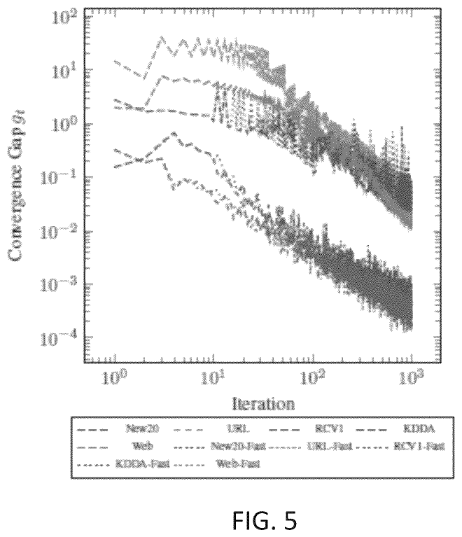

FIG. 5 illustrates a plot of convergence gap to number of iterations for algorithm C in accordance with an exemplary embodiment of the present disclosure. As shown in FIG. 5, the algorithm C converges to the same solution as the known Frank-Wolfe algorithm. For example, in algorithm C, the updating in differences can cause catastrophic cancellation due to the zig-zag behavior of Frank-Wolfe iterates, resulting in similar magnitude sign changes that result in slightly different results numerically compared to re-computing the entire gradient from scratch.

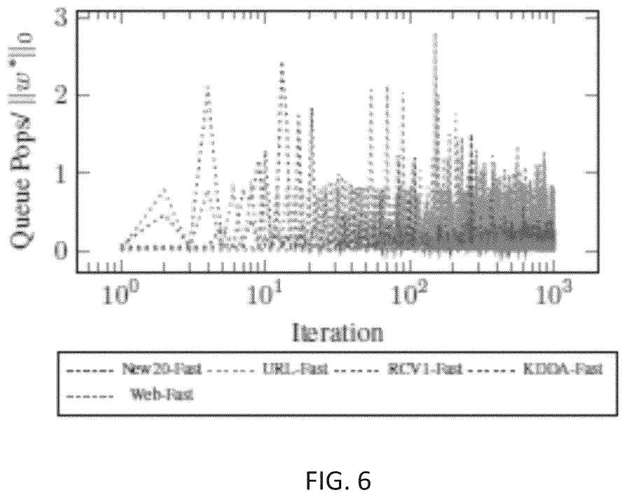

FIG. 6 illustrates a plot of items popped from a Figonacci Heap over the non-zeroes in the final solution to the number of iterations in accordance with an exemplary embodiment of the present disclosure. FIG. 6 provides a validation of the O(∥w*∥0) number of times the Fibonacci Heap can be queried for selecting the next iterate, by plotting ratio of the number of times an item from the Heap is popped against the value of ∥w*∥0 over training iterations of FIG. 5. As shown in FIG. 6, in executing Algorithm B, processor 104 does not need to consider all D possible features to select the correct iterate.

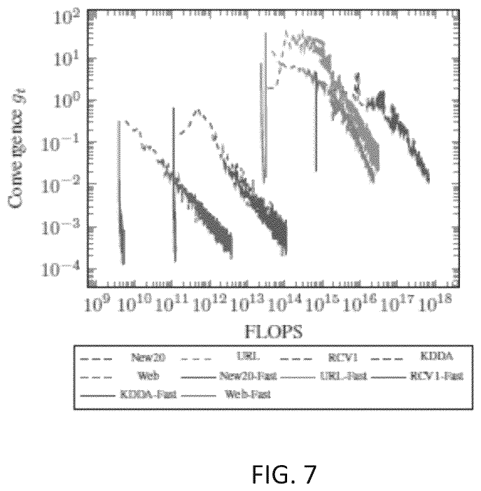

FIG. 7 illustrates a plot of convergence rate as a function of the number of FLOPs to obtain it in accordance with an exemplary embodiment of the present disclosure. As shown in FIG. 7, the Algorithm A (solid lines) reduces the required number of numerical steps by multiple orders of magnitude over the known Frank-Wolfe Algorithm (dashed lines) in accordance with an exemplary embodiment of the present disclosure.

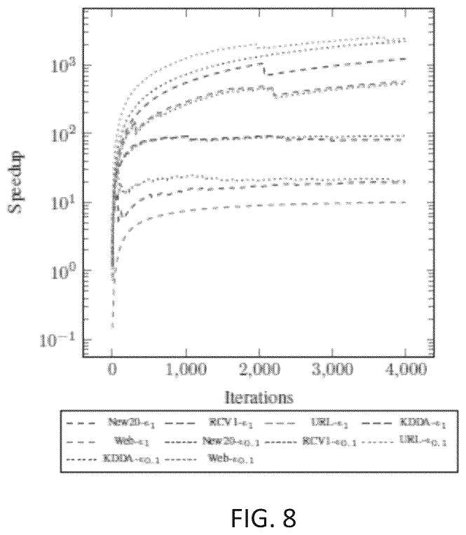

FIG. 8 illustrates a plot of total cumulative reduction in runtime (y-axis) against the number of completed iterations (x-axis) of algorithm C in accordance with an exemplary embodiment of the present disclosure. As shown in FIG. 8, through execution of algorithms A, B, and C the processor 104 is configured to produce from a 10× improvement in runtime for the URL dataset at the low end, up to a 1200× improvement in runtime for the KDDA and URL datasets at ∈=0.1. As the ∈ decreases, e.g., the solution becomes more private, the improvement in runtime of the processor 104 also increases. As ϵ becomes smaller the choice of the next coordinate direction j begins to approach the uniform distribution, resulting in the processor 104 selecting more features with lower density (i.e., increased sparsity). Thus, even fewer FLOPs become necessary to perform each iteration of Algorithm A, whereas a known implementation of the Frank-Wolfe algorithm can perform the same amount of work regardless of the update direction.

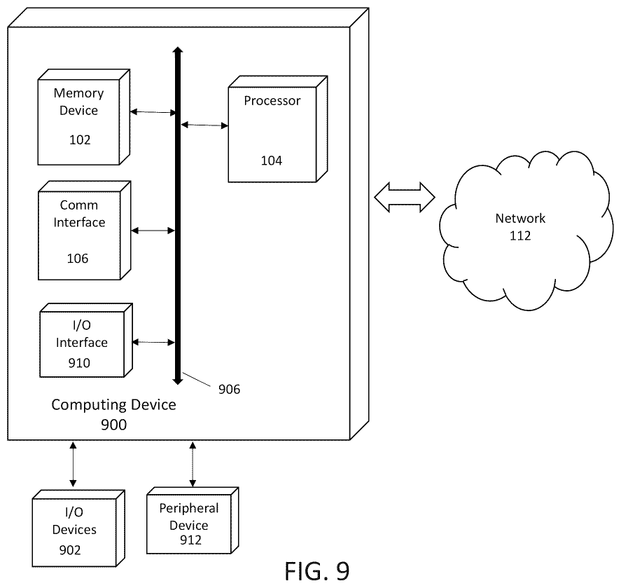

FIG. 9 illustrates the structure of a computing system in accordance with an exemplary embodiment of the present disclosure. As shown in FIG. 9, the computing systems 100 of FIGS. 1 and 2 can further include one or more input devices 902, the communication interface 106, an internal communication infrastructure 906, and an input/output (I/O) interface 910. According to exemplary embodiments of the present disclosure, the one or more input devices 902 can be configured to receive commands and/or allow a user to interact (e.g., input data and/or commands) with the computing device. The one or more input devices 902 can include one or more of a physical or virtual keyboard, a touchpad, a mouse or stylus, microphone, camera or any other suitable input device as desired. The communication interface 106 can include a combination of hardware and software components configured as a receiver 108 to receive streaming data from one or more other computing devices connected to the network 112, a data lake, the cloud, or any other suitable component on the network as desired. According to exemplary embodiments, the receiver 108 can include a hardware component such as an antenna, a network interface (e.g., an Ethernet card), a communications port, a PCMCIA slot and card, or any other suitable component or device as desired. The receiver 108 can be connected to other devices via a wired or wireless network or via a wired or wireless direct link or peer-to-peer connection without an intermediate device or access point. The hardware and software components of the receiver 108 can be configured to receive data (e.g., streaming data) according to one or more communication protocols and data formats. The communication interface 106 can be configured to communicate over a network 112, such as enterprise network, which may include a local area network (LAN), a wide area network (WAN), a wireless network (e.g., Wi-Fi), a cellular communication network, a satellite network, the Internet, fiber optic cable, coaxial cable, infrared, radio frequency (RF), another suitable communication medium as desired, or any combination thereof. During a receive operation, the receiver 108 can be configured to identify parts of the received data via a header and parse the data signal and/or data packet into small frames (e.g., bytes, words) or segments for further processing at the processor 104.

The processor 104 can be a special purpose or a general purpose processing device encoded with program code or software for performing the exemplary functions and/or features disclosed herein. According to exemplary embodiments of the present disclosure, the processor 104 can include a central processing unit (CPU). The processor 104 can be connected to the communications infrastructure 906 including a bus, message queue, or network, multi-core message-passing scheme, for communicating with other components of the computing device 900, such as the memory 102, the one or more input devices 904, the communication interface 106, and the I/O interface 910. The processor 104 can include one or more processing devices such as a microprocessor, microcomputer, programmable logic unit or any other suitable hardware processing devices as desired.

The I/O interface 910 can be configured to receive the signal from the processor 104 and generate an output suitable for a peripheral device via a direct wired or wireless link. The I/O interface 910 can include a combination of hardware and software for example, a processor, circuit card, or any other suitable hardware device encoded with program code, software, and/or firmware for communicating with a peripheral device such as a display device, printer, audio output device, or other suitable electronic device or output type as desired. The I/O interface 910 can also be configured to connect and/or communicate with or in combination with other hardware components provide the functionality of various types of integrated and/or peripheral input devices described herein.

The communications interface 106 can also be configured as a transmitter 110, which receives data from the processor 104 and/or memory 102 and assemble the data into a data signal and/or data packets according to the specified communication protocol and data format of a peripheral device or remote device to which the data is to be sent. The transmitter 110 can include any one or more of hardware and software components for generating and communicating the data signal over the internal communication infrastructure 906 and/or via a direct wired or wireless link to a peripheral or remote device 912. The transmitter 110 can be configured to transmit information according to one or more communication protocols and data formats as discussed in connection with the receiver 108. As already discussed, the receiver 108 and the transmitter 110 can be integrated into a single device and/or housing or configured as separate and independent devices. According to another exemplary embodiment, and as already discussed, the receiver 108 and the transmitter 110 can be configured shared circuitry and components and can be further integrated with the communication interface 106.

According to exemplary embodiments described herein, the combination of the memory 102 and the processor 104 can store and/or execute computer program code for performing the specialized functions described herein. It should be understood that the program code could be stored on a non-transitory computer readable medium, such as the memory devices for the computing device 900, which may be memory semiconductors (e.g., DRAMs, etc.) or other tangible and non-transitory means for providing software to the computing device 900. For example, via any known or suitable service or platform, the program code can be deployed (e.g., streamed and/or downloaded) remotely from computing devices located on a local-area or wide-area network and/or in a cloud-computing arrangement or environment, with a source-controlled (e.g., git, gitops, etc.) and container orchestration process. The computer programs (e.g., computer control logic) or software may be stored in memory 102 resident on/in the computing device 900. Such computer programs or software, when executed, may enable the computing device 900 to implement the present methods and exemplary embodiments discussed herein. Accordingly, such computer programs may represent controllers of the computing device 900. Where the present disclosure is implemented using software, the software may be stored in a computer program product or non-transitory computer readable medium and loaded into the computing device 900 using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processor(s) (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the computing device 900 and/or the components of an enterprise network to perform the functions disclosed herein. It will be apparent to persons having skill in the relevant art that such processes result in the computing device 900 and/or the components of the enterprise network being specially configured computing devices uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A method for training a model, the method comprising:
storing, in memory, program code for training a machine learning model and for preventing leakage of training data by the machine learning model subsequent to training; and
executing, in a processor, the program code stored in memory, the program code causing the processor to be configured to execute operations including:
a. receiving a dataset populated predominately with zero data values as a sparse dataset;
b. converting the sparse dataset into a matrix of plural data coordinates defined by a feature value and a column gradient;
c. generating a priority queue populated with the plural data coordinates;
d. iteratively selecting a data coordinate from the priority queue, each coordinate indicating a next covariate to update in the machine learning model;
e. calculating based on the selected data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model, in such a manner that any zero value in the sparse dataset is avoided in use while maintaining a same result;
f. selecting a next data coordinate from the plural data coordinates in the priority queue, the next data coordinate corresponding to a next feature for training the model;
g. altering a weight value of the next feature to produce an altered weight value;
h. updating plural variables of the matrix based on the altered weight value, the plural variables being located in rows of the matrix that include the next feature, the plural variables including at least the column gradient, the dot product of each row of the matrix that includes the next feature in the matrix with the altered weight value, and the base convergence gap value associated with training of the machine learning model;
i. updating the priority queue to adjust a priority of the data coordinates based on the update to the plural variables; and
j. repeating steps f to i until the model has converged to a solution.

2. The method of claim 1, wherein the program code causes the processor to select a next data coordinate for analysis by performing operations including:
k. multiplying the data coordinates in the priority queue by a scaling variable having a noise parameter;
l. computing a threshold weight value for each feature to be used in training the machine learning model;
m. generating plural groups of data coordinates of the matrix by populating each group with data coordinates that are randomly selected based on a proportionality of a corresponding weight value to the threshold weight value;
n. computing a cumulative weight value for each group of data coordinates;
o. comparing the cumulative weight value of a current group of the plural groups to the threshold weight value;
p. selecting a new group of compiled data coordinates from the plural groups when the cumulative weight value of the current group is smaller than the threshold weight value;
q. inspecting each data coordinate in the current group when the cumulative weight value of the current group is larger than the threshold weight value; and
r. repeating steps n to q to select the next priority item with randomness so that privacy is maintained according to a predetermined sensitivity.

3. The method of claim 2, wherein the operation comprises:
identifying the next data coordinate in the current group based on a result of the inspecting operation.

4. The method of claim 2, wherein the operation of compiling a current group of random data coordinates comprises:
identifying data coordinates in the current group that were included in a previous comparison; and
subtracting a weight value of the identified data coordinates in the previous comparison from the threshold weight value.

5. A system for training a model, the system comprising:
memory configured to store program code for training a machine learning model and for preventing leakage of training data by the machine learning model subsequent to training; and
a processor configured to execute the program code stored in memory, the program code causing the processor to be configured to:
a. receive a dataset populated predominately with zero data values as a sparse dataset;
b. convert the sparse dataset into a matrix of plural data coordinates defined by a feature value and a column gradient;
c. generate a priority queue populated with the plural data coordinates;
d. iteratively select a data coordinate from the priority queue, each data a next covariate to update in the machine learning model;
e. calculate, based on the first data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model in such a manner that any zero value in the sparse dataset is avoided in use while maintaining a same result;
f. select a next data coordinate from the plural data coordinates in the priority queue, the next data coordinate corresponding to a next feature for training the model;
g. alter a weight value of the next feature to produce an altered weight value;
h. update plural variables of the matrix based on the altered weight value, the plural variables being located in rows of the matrix that include the next feature, the plural variables including at least the column gradient, the dot product of each row of the matrix that includes the next feature in the matrix with the altered weight value, and the base convergence gap value associated with training of the machine learning model;
i. update the priority queue to adjust a priority of the data coordinates based on the update to the plural variables; and
j. repeat steps f to i until the model has converged to a solution.

6. The system of claim 5, to select a next data coordinate for analysis, the processor is configured to:
k. multiply the data coordinates in the priority queue by a scaling variable having a noise parameter;
l. compute a threshold weight value for each feature to be used in training the machine learning model;
m. generate plural groups of data coordinates of the matrix by populating each group with data coordinates that are randomly selected based on a proportionality of a corresponding weight value to the threshold weight value;
n. compute a cumulative weight value for each group of data coordinates;
o. compare the cumulative weight value of a current group of the plural groups to the threshold weight value;
p. select a new group of compiled data coordinates from the plural groups when the cumulative weight value of the current group is smaller than the threshold weight value;
q. inspect each data coordinate in the current group when the cumulative weight value of the current group is larger than the threshold weight value; and
r. repeat steps n to q to select the next priority item with randomness so that privacy is maintained according to a predetermined sensitivity.

7. The system of claim 6, the processor is further configured to:
identify the next data coordinate in the current group based on a result of the inspecting operation.

8. The system of claim 6, wherein to compile a current group of random data coordinates, the processor is configured to:
identify data coordinates in the current group that were included in a previous comparison; and
subtract a weight value of the identified data coordinates in the previous comparison from the threshold weight value.

9. A computer program product encoded with program code for training a machine learning model and for preventing leakage of training data by the machine learning model subsequent to training such that when placed in communicable contact with a processor, the computer program product causes the processor to be configured to execute operations including:
a. receiving a dataset populated predominately with zero data values as a sparse dataset;
b. converting the sparse dataset into a matrix of plural data coordinates defined by a feature value and a column gradient;
c. generating a priority queue populated with the plural data coordinates;
d. iteratively selecting a data coordinate from the priority queue, each coordinate indicating a next covariate to update in the machine learning model;
e. calculating based on the selected data coordinate, at least a first gradient value as a row gradient of the matrix, a second gradient value as a column gradient of the matrix, a dot product of the row gradient with a weight value of the feature associated with the first data coordinate, and a convergence gap value as a base convergence gap value of the machine learning model, in such a manner that any zero value in the sparse dataset is avoided in use while maintaining a same result;
f. selecting a next data coordinate from the plural data coordinates in the priority queue, the next data coordinate corresponding to a next feature for training the model;
g. altering a weight value of the next feature to produce an altered weight value;
h. updating plural variables of the matrix based on the altered weight value, the plural variables being located in rows of the matrix that include the next feature, the plural variables including at least the column gradient, the dot product of each row of the matrix that includes the next feature in the matrix with the altered weight value, and the base convergence gap value associated with training of the machine learning model;
i. updating the priority queue to adjust a priority of the data coordinates based on the update to the plural variables; and
j. repeating steps f to i until the model has converged to a solution.
